(19) United States
(12) Patent Application Publication
(10) Pub. No.: US 2011/0197807 A1
(43) Pub. Date: Aug. 18, 2011

(54) SILENT WAITER

(76) Inventor: REGIS A. MANNKE, JR., Pittsburgh, PA (US)

(21) Appl. No.: 12/705,769

(22) Filed: Feb. 15, 2010

(51) Int. Cl. G09F 9/00

(52) U.S. Cl. 116/306

(57) ABSTRACT

An apparatus for providing a silent signal to a waiter/waitress that one of service is required and service is not required. The apparatus comprises a base member and an upper member. Such base member is colored red and such upper member is colored green. When the red base member is on top it is a signal to the waiter/waitress that service is not needed. When the apparatus is turned over so that the green color is on top it is a signal to the waiter/waitress that service is needed. The apparatus further includes a light to make the apparatus more visible.

### FIELD OF THE INVENTION

The present invention relates, in general, to a table accessory, and, more particularly, the present invention relates to an apparatus for providing a silent signal to a waiter indicating a need for service or that no service is needed so as to eliminate unneeded intrusions by such waiter/waitress.

### STATEMENT REGARDING FEDERALLY SPONSORED RESEARCH OR DEVELOPMENT

N/A

### BACKGROUND OF THE INVENTION

Everyone has been in a restaurant and has experienced at one time or another a waiter/waitress who has never checked at the table to see if there was need for a coffee refill or any other need. The waiter/waitress was only evident to take and deliver the order and to present the check. On the other hand everyone has experienced a waiter/waitress who is stopping at the table every few minutes to see if there is a need for something. Both of these situations can result in an irritation to the restaurant goer in what should have been a pleasant dining experience.

Thus, it would be advantageous if there were an apparatus or a means for enabling the restaurant goer to be able to have a signal means at the table whereby he/she can indicate to the waiter/waitress that service is desired or as an alternative that there is presently no need for service.

### SUMMARY OF THE INVENTION

In a first aspect the present invention provides an apparatus for providing a silent signal to a waiter/waitress that one of service is required and service is not required. The apparatus comprises a first member having a substantially flat portion, such first member having a first predetermined shape and formed of a first predetermined material and having a first predetermined color, A second member has a substantially flat portion, such second member having a second predetermined shape and formed of a second predetermined material and having a second predetermined color. At least one wall member is disposed on one of the first member and the second member and extends around a periphery thereof. Such at least one wall member having a first predetermined height. There is a first means having a first portion engageable with the first member and a second portion engageable with the second member for securing the second member to the first member.

In a second aspect the present invention provides an apparatus for providing a silent signal to a waiter/waitress that one of service is required and service is not needed. Such apparatus comprises a first member having a substantially flat bottom portion and an upwardly extending wall member engageable with such flat bottom portion, such first member having a first predetermined shape and formed of a first predetermined material and having a first predetermined color. A second member having a substantially flat portion and having a wall member extending downwardly therefrom, such second member engageable on a bottom surface of the wall member with an upper surface of the upwardly extending wall member of such first member and having a second predetermined shape and formed of a second predetermined material and having a second predetermined color. A first means is disposed having a first portion engageable with such first member and a second portion engageable with the second member for securing such second member to the first member. There is a lighted member disposed within such first member for providing a light so that the apparatus will be more visible. A second means is disposed within such first member for providing power to the lighted member.

In a third aspect the present invention provides an apparatus for providing a silent signal to a waiter/waitress that one of service is required and service is not needed. The apparatus comprises a member having a predetermined size, a predetermined shape and formed of a predetermined material, such member having a first side and a second side, such first side having a first predetermined color and such second side having a different second predetermined color.

### OBJECTS OF THE INVENTION

It is, therefore, one of the primary objects of the present invention to provide a means of a silent signal to the waiter/waitress that service is either required or not needed.

Another object of the present invention to provide a means of a silent signal to the waiter/waitress that includes a substantially flat signaling member that is colored red on one side and green on the other.

Still another object of the present invention to provide a means of a silent signal to the waiter/waitress that includes a light within such substantially flat member.

Yet another object of the present invention to provide a means of a silent signal to the waiter/waitress wherein the shape of the apparatus is designed to suggest various sports such as football, hockey, soccer, basketball or baseball.

Still another object of the present invention to provide a means of a silent signal to the waiter/waitress wherein the shape of the apparatus is selected from various shapes such as star shaped, X-shaped, oval, pentagonal, hexagonal, octagonal, rectangular, square or circular.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a perspective view of a base member of the apparatus according to an embodiment of the invention for signaling a waiter/waitress.

FIG. 2 is a is a top perspective view of the complete apparatus formed in the shape of a hockey puck.

FIG. 3 is a perspective view of the underside of the upper member.

FIG. 4 is a perspective view of an unassembled apparatus showing the base member and the upper member for signaling to a waiter/waitress.

FIGS. 5 A & 5B are top views of two possible shapes of the apparatus showing a round shape and a football shape.

FIG. 6 A-D are top views of four other possible shapes for the apparatus showing a pentagon, hexagon, square and heart shapes.

FIG. 7 A-D are top views of other possible shapes for the apparatus showing a rectangle, triangle, six pointed star, and a five pointed star.

FIG. 8 is a top perspective view of the apparatus according to an alternate embodiment of the invention.

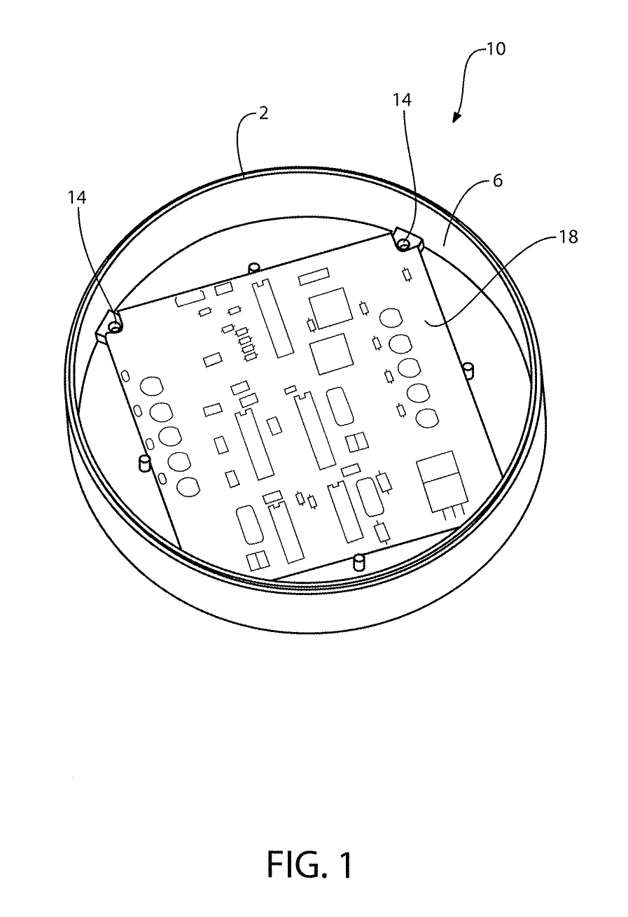

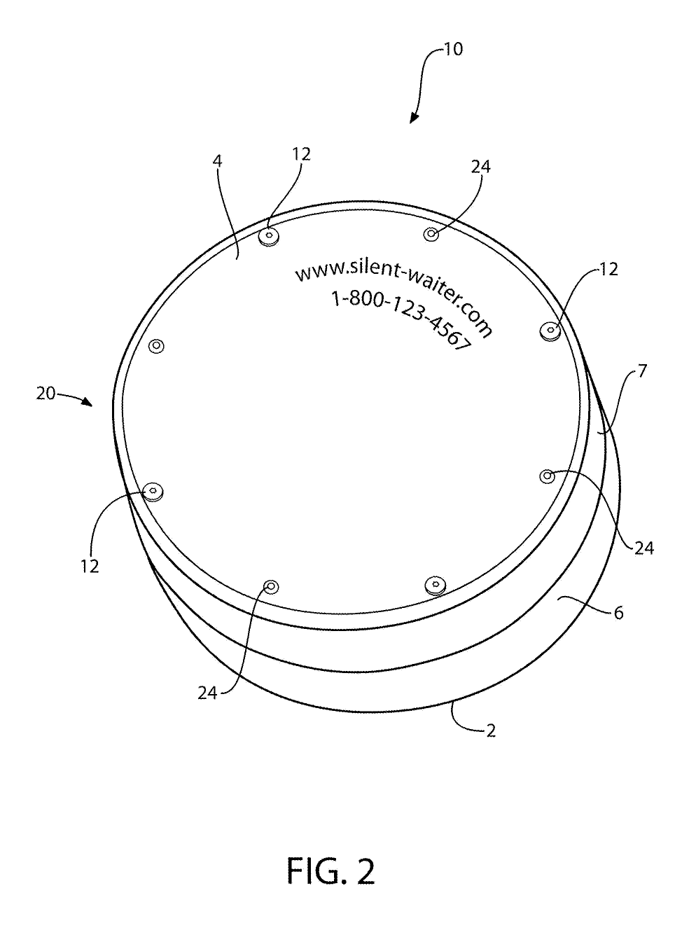

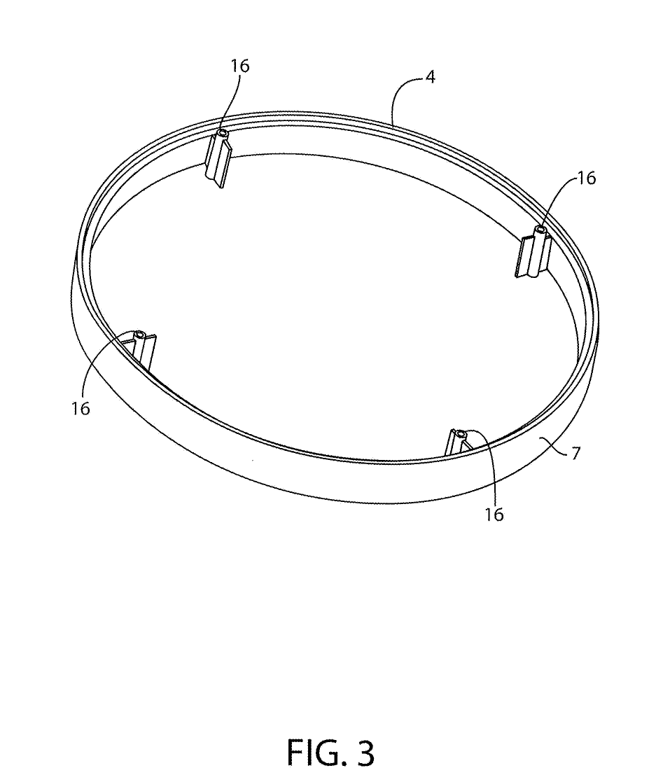

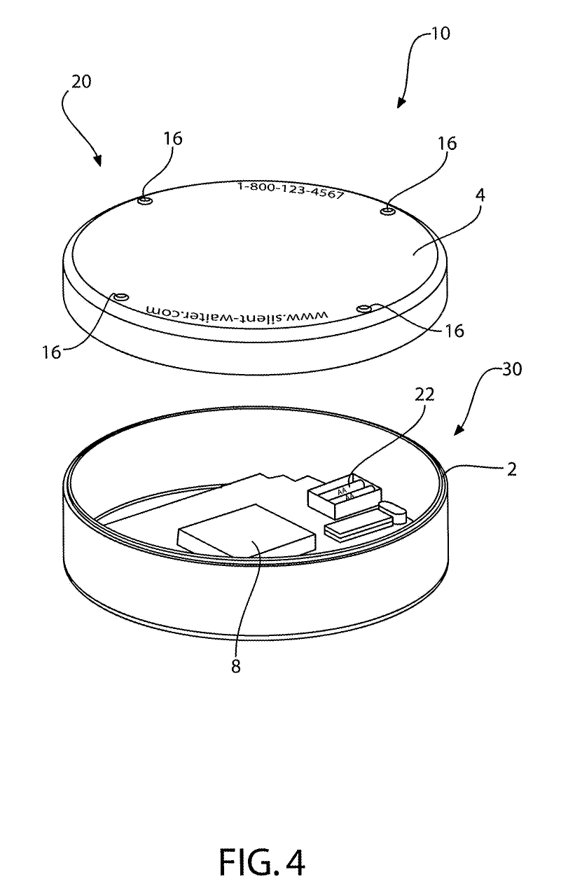

### DETAILED DESCRIPTION OF INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for providing a silent signal to a waiter/waitress that one of service is required or that service is not required. The apparatus 10 comprises a first member 2 having a first predetermined shape and formed of a first predetermined material, such first member 3 having a substantially flat portion and having a first predetermined color. There is a second member 4 having a substantially flat portion and having a second predetermined shape and formed of a second predetermined material and having a second predetermined color. At least one wall member 6 is disposed on one of the first member 2 and the second member 4 and extends around a periphery thereof. Such at least one wall member 6 having a first predetermined height. A first means 20 has a first portion engageable with such first member and a second portion engageable with the second member for securing the second member 4 to the first member 2. A lighted member 8 is disposed within one of the first member 2 and the second member 4 for providing a light 8 so that the apparatus will be more visible. A second means 30 is disposed within one of the first member 2 and the second member 4 for providing power to such lighted member 8.

It is presently preferred that such at least one wall member 6 is disposed around a periphery of the first member 2 and extends upwardly therefrom. In one embodiment of the invention such second member 4 is substantially a flat lid member engageable with an upper surface of the at least one wall member 6. It is presently preferred that an outer perimeter shape of the first member 2 and the second member 4 are substantially identical.

In an alternate embodiment of the invention such first member 2 and such second member 4 each have a wall member 6 extending outwardly therefrom.

It is presently preferred that such first wall member 6 is disposed around a periphery of the first member 2 extending upwardly therefrom, such first wall member 6 having a first predetermined height.

In an embodiment of the invention a second wall member 7 is disposed around a periphery of the second member 4 extending downwardly therefrom, such second wall member 4 having a second predetermined height. Such second wall member 7 is engageable on a bottom surface thereof with an upper surface of the first wall member 6.

In a preferred embodiment of the invention such first predetermined color is red and such second predetermined color is green. Thus, if service is not required the apparatus is positioned so that the red color is on top whereas if service is required the apparatus is turned over and the green color is on top. The waiter/waitress can just look at the apparatus 10 to determine if he/she should stop at the table or not.

In an alternate embodiment of the invention there is provided an apparatus for providing a silent signal to a waiter/waitress that one of service is required and service is not needed, the apparatus 10 comprises a first member 2 having a substantially flat bottom portion and an upwardly extending first wall member 6 engageable with the flat bottom portion, such first member 4 having a first predetermined shape and formed of a first predetermined material and having a first predetermined color. A second member 4 has a substantially flat portion and has a second wall member 7 extending downwardly therefrom, such second member 4 is engageable on a bottom surface of the wall member 7 with an upper surface of said upwardly extending wall member 6 of the first member 2 and has a second predetermined shape and is formed of a second predetermined material, such second member 4 having a second predetermined color. A first means 20 is disposed having a first portion engageable with the first member and a second portion engageable with the second member for securing the second member 4 to the first member 2. A lighted member 8 is disposed within the first member 2 for providing a light 8 so that such apparatus 10 will be more visible and a second means 30 is disposed within the first member for providing power to such lighted member 8.

Such first means 20 includes a plurality of screws 12 for securing the second member 4 to the first member 2. Such first means 20 further includes receptacles 14 disposed on an inner bottom surface of the first member 2 for receiving such screws 12. The receptacles 14 are disposed at predetermined locations on such inner bottom surface.

Such second member further includes a plurality of screw holes 16 that are disposed through such second member 4 further includes a plurality of screw holes that are disposed through such second member 4 at predetermined locations therein corresponding to the predetermined locations of the receptacles 14 on such inner bottom surface of the first member 2 for positioning such screws 12 so as to engage the receptacles 14.

Such second means 30 includes a circuit board 18 and at least one battery 22 wherein it is preferred that such battery 22 is either a AA battery or a AAA battery. It is also an embodiment of the invention wherein such battery could be a rechargeable battery. It is further within the concept of the invention wherein such battery is a nine volt battery.

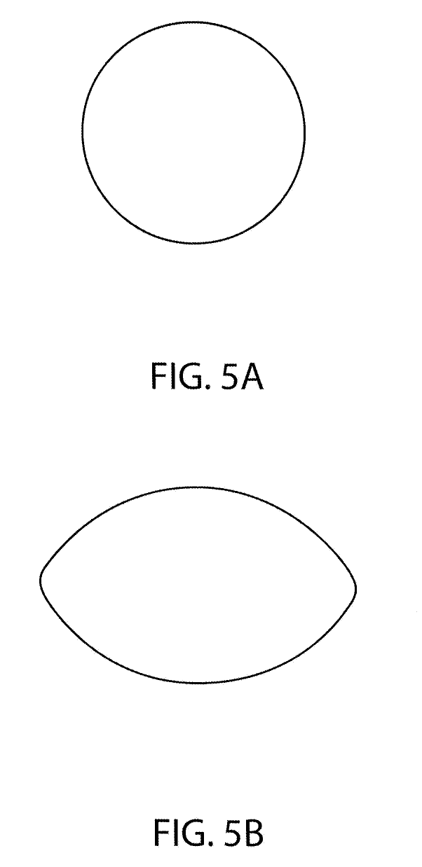

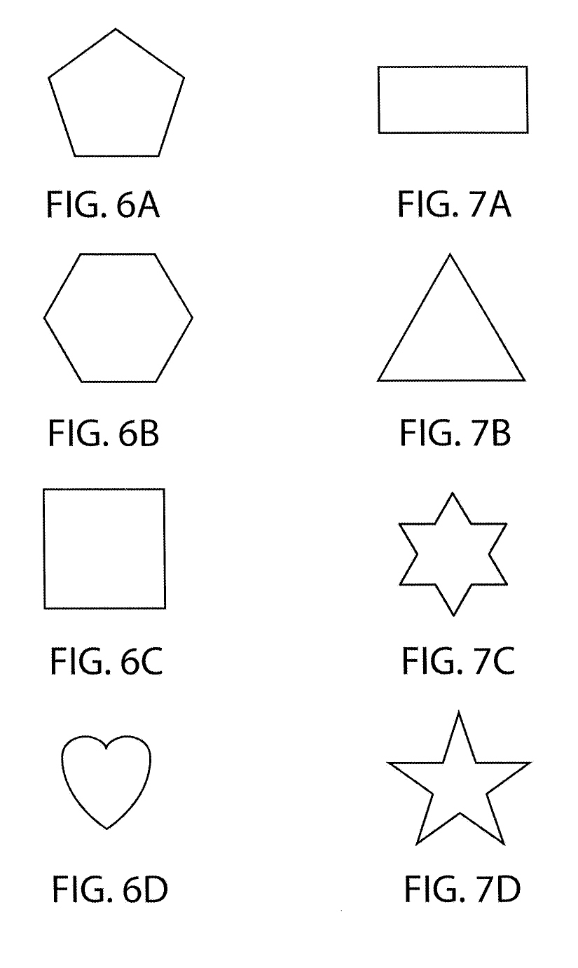

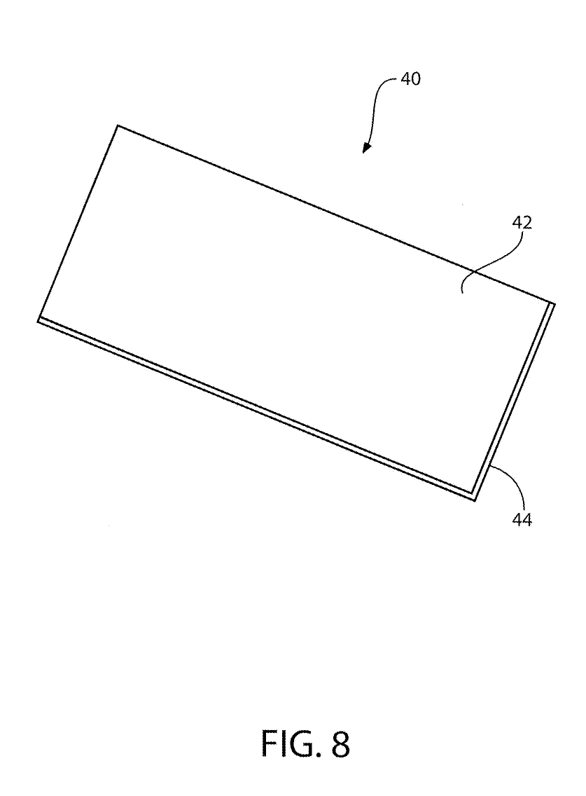

It is also presently preferred that such first and such second predetermined shape of the first 2 and the second member 4 is selected from one of circular, oval, rectangular, triangular, square, pentagonal, hexagonal, octagonal and star shaped as is seen in FIGS. 5, 6 and 7. It is also an embodiment of the invention wherein a sticker can be placed on the first and/or second member to indicate a sport such as providing seams to indicate a baseball. Also such sticker could also be used for advertisement.

It is also preferred that such first member 2 includes a plurality of dimples 24 disposed on an outer bottom surface thereof and such second member 4 includes a plurality of dimples 24 disposed on an outer top surface thereof for providing a scratch resistant surface to whatever surface said apparatus 10 is sitting on.

It should be noted that although most of the Figures show the apparatus in the form of a hockey puck it is within the scope of the invention that the shape could be any common shape. As seen in FIGS. 5-7 different shapes are shown. Thus, the silent waiter could be round as with the hockey puck but it could be designed to look like a baseball, basketball, soccer ball, tennis ball or a golf ball. In the case of the golf ball the surface would be dimpled as is found on golf balls or having seams to look like a baseball. Further, the round format could also represent items other than sports equipment. It could also be a pizza, hamburger, sun, moon, pool ball or a planet. Some other possible shapes could be in the shape of a football, rectangle, triangle, square, heart, pentagon, hexagon, octagon and a star having either five or six points.

In a third aspect the present invention provides an apparatus 40 for providing a silent signal to a waiter/waitress that one of service is required and service is not needed. The apparatus comprises a member having a predetermined size, a predetermined shape and formed of a predetermined material, such member having a first side 42 and a second side 44, such first side 42 having a first predetermined color and such second side 44 having a different second predetermined color. Such apparatus 40 could be formed of cardboard or plastic having one side colored red and having the opposed side colored green.

Thus, the present invention provides a silent signal to a waiter/waitress that service is either required or not needed. The consumer doesn't have to wave to catch the attention of the waiter when service is needed or having to tell the waiter that we don't need service when the waiter constantly stops at the table. All the consumer has to do is turn the signaling member so that one of a green portion or a red portion is on top and the waiter/waitress knows immediately whether to stop at the table or leave the table alone without the consumer calling or watching for the waiter/waitress. The apparatus 10, 40 is positioned with the red side on top if service is not required and is turned over so that the green side is on top if service is required. It should also be mentioned that the apparatus further includes a tilt switch mechanism wherein the light goes on when the apparatus is tilted over. It is also within the concept of the invention wherein the apparatus could be used to page the waiter/waitress by use of an RF band.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for providing a silent signal to a waiter/waitress that one of service is required and service is not needed, said apparatus comprising:
(a) a first member having a substantially flat portion, said first member having a first predetermined shape and formed of a first predetermined material and having a first predetermined color;
(b) a second member having a substantially flat portion, said second member having a second predetermined shape and formed of a second predetermined material and having a second predetermined color;
(c) at least one wall member disposed on one of said first member and said second member and extending around a periphery thereof, said at least one wall member having a first predetermined height; and
(d) a first means having a first portion engageable with said first member and a second portion engageable with said second member for securing said second member to said first member.

2. The apparatus, according to claim 1, wherein said apparatus includes a lighted member disposed within one of said first member and said second member for providing a light so that said apparatus will be more visible and a second means disposed within one of said first member and said second member for providing power to said lighted member.

3. The apparatus, according to claim 1, wherein a first wall member of said at least one wall member is disposed around a periphery of said first member and extends upwardly therefrom, said at least one wall member having a first predetermined height.

4. The apparatus according to claim 3, wherein said second member is substantially a flat lid member engageable with an upper surface of said at least one wall member.

5. The apparatus, according to claim 1, wherein an outer perimeter shape of said first member and said second member are substantially identical.

6. The apparatus, according to claim 3, wherein said first member and said second member each have a wall member extending outwardly therefrom.

7. The apparatus, according to claim 6, wherein a second wall member is disposed around a periphery of said second member and extends downwardly therefrom, said second wall member having a second predetermined height.

8. The apparatus, according to claim 7, wherein said second wall member is engageable on a bottom surface thereof with an upper surface of said first wall member.

9. The apparatus, according to claim 1, wherein said first predetermined color is red.

10. The apparatus, according to claim 1, wherein said second predetermined color is green.

11. An apparatus for providing a silent signal to a waiter/waitress that one of service is required and service is not needed, said apparatus comprising:
(a) a first member having a substantially flat bottom portion and an upwardly extending wall member engageable with said flat bottom portion, said first member having a first predetermined shape and formed of a first predetermined material, said first member having a first predetermined color;
(b) a second member having a substantially flat portion and having a wall member extending downwardly therefrom, said second member engageable on a bottom surface of said wall member with an upper surface of said upwardly extending wall member of said first member and having a second predetermined shape and formed of a second predetermined material, said second member having a second predetermined color;
(c) a first means is disposed having a first portion engageable with said first member and a second portion engageable with said second member for securing said second member to said first member;
(d) a lighted member disposed within said first member for providing a light so that said apparatus will be more visible; and
(e) a second means disposed within said first member for providing power to said lighted member.

12. The apparatus, according to claim 11, wherein said first means includes a plurality of screws for securing said second member to said first member.

13. The apparatus, according to claim 12, wherein said first means further includes receptacles disposed on an inner bottom surface of said first member for receiving said screws, said receptacles disposed at predetermined locations on said inner bottom surface.

14. The apparatus, according to claim 13, wherein said second member further includes a plurality of screw holes disposed through said second member at predetermined locations therein corresponding to said predetermined locations of said receptacles on said inner bottom surface of said first member for positioning said screws so as to engage said receptacles.

15. The apparatus, according to claim 11, wherein said second means includes a circuit board and at least one battery.

16. The apparatus, according to claim 15, wherein said battery is a AA battery.

17. The apparatus, according to claim 11, wherein said first and said second predetermined shape of said first and said second member is selected from one of circular, oval, rectangular, square, hexagonal, octagonal and star shaped.

18. The apparatus, according to claim 11, wherein said first member includes a plurality of dimples disposed on an outer bottom surface thereof for providing a scratch resistant surface to whatever surface said apparatus is sitting on.

19. The apparatus, according to claim 18, wherein said second member includes a plurality of dimples disposed on an outer top surface thereof for providing a scratch resistant surface to whatever surface said apparatus is sitting on when said apparatus is turned over.

20. The apparatus, according to claim 19, wherein said plurality of dimples are disposed symmetrically on said surface of said first and said second member.

21. An apparatus for providing a silent signal to a waiter/waitress that one of service is required and service is not needed, said apparatus comprising a member having a predetermined size, a predetermined shape and formed of a predetermined material said member having a first side and a second side, said first side having a first predetermined color and said second side having a different second predetermined color.
